(19) United States
(12) Patent Application Publication
(10) Pub. No.: US 2015/0206202 A1
(43) Pub. Date: Jul. 23, 2015

(54) METHODS AND APPARATUS FOR INTELLECTUAL PROPERTY BASED FINANCIAL OFFERING

(71) Applicant: Springtime, Jacksonville, FL (US)

(72) Inventors: William D. Meadow, Jacksonville, FL (US); Joseph P. Kincart, Jacksonville, FL (US)

(21) Appl. No.: 14/568,806

(22) Filed: Dec. 12, 2014

Related U.S. Application Data
(60) Provisional application No. 61/915,205, filed on Dec. 12, 2013.

(51) Int. Cl. G06Q 30/02; G06Q 50/18

(52) U.S. Cl. CPC G06Q 30/0279; G06Q 40/06; G06Q 50/184

(57) ABSTRACT

The present invention provides apparatus and methods for providing funding to the advancement of science and technology while insulating the investment from other market factors, such as available angel investors, venture capital, corporate licensing partners for the productization of an invention, initial management business performance and market conditions. In addition, methods and apparatus are provided for administering charitable donations to a university or other learning institution to fund science and technology.

### CROSS REFERENCE TO PRIOR RELATED APPLICATIONS

The present disclosure claims priority to U.S. Provisional Patent Application Ser. No. 61/915,205, entitled METHODS AND APPARATUS FOR INTELLECTUAL PROPERTY BASED FINANCIAL OFFERING, and filed Dec. 12, 2013, the contents of which are relied upon and incorporated by reference.

### BACKGROUND

This invention relates to methods and apparatus for facilitating funding of scientific research and technology advancement. In particular, the present invention relates to a computerized system and method for structuring a financial model and relationship that enables an educational institution or other interested third party to issue a financial instrument backed by intellectual property.

Currently, it is commonplace to provide contributions to educational endeavors in the form of donations. Projects and institutions who are potential recipients compete for finite funds that may be utilized to finance a new resource or project. Once the funds have been dispersed, additional funds must be raised or the cycle ceases. The net result is that some projects in areas of promising technological advancement remain unfunded. Unfunded technology advancement has a trickledown effect of stifling economic growth. In addition, traditionally, collaboration between universities has been minimal which stifles joint ownership and joint licensing opportunities.

Another aspect of the current model that stifles innovation is that universities often compete for available research funding. The competition limits collaboration amongst several universities, even if such collaboration would bring together multiple experts on a given project.

As observed by Carl Sagan, “We've arranged a civilization in which most crucial elements profoundly depend on science and technology.” However, the vehicles for advancing science and technology are underfunded. The current funding system promotes investment in organizations, such as corporations or small startup companies. The success of a venture pursuing advancement in science or technology is therefore caught up in the ability of the people involved in the organization to acquire and manage funding. Not surprisingly, the great majority of start-up ventures fail. Scientists and other creative people do not always equate with people with the talents necessary to make a business venture successful.

In recent cases, companies with very worthwhile Intellectual Property fail due to other causes, such as mismanagement, or the inventions are simply too early for the market or the overall economic market conditions are poor. In such instances, often the Intellectual Property is the most valuable asset owned by the failed or failing company and yet the IP asset is not protected from “fire sale” disposition of a potentially highly valuable asset.

What is needed is a financial vehicle for funding the very earliest stage of advancement in science and technology IP development while relieving the innovative technically skilled people from the attempting to develop their IP assets.

### SUMMARY

Accordingly, the present invention provides apparatus and methods for providing funding to the advancement of science and technology while greatly insulating the investment from other market factors, such as available angel investors, venture capital, corporate licensing partners for the productization of an invention, initial management business performance and market conditions. In addition, methods and apparatus are provided for administering charitable donations to a university or other learning institution to fund science and technology and also provide a return of the amount donated at a later date plus a return on the original donation investment. Charitable endeavors may include for example better mechanisms for provision of basic essentials of the human condition, such as decent food, water and shelter.

The present invention will also include methods and apparatus to promote the advancement of the sciences at the university level. As Carl Sagan is also attributed with observing with amazement: “how much more capability and enthusiasm for science there is among elementary school youngsters than among college students.” The present invention provides methods and apparatus to reward universities financially and reputationally for the advancement of science and technology in a manner similar to university sports programs.

Increased enthusiasm for science and technology may be accomplished by tying wealth creation to purposefully developed generations of new technology. In the present invention, a computerized system is provided for generating and managing financial instruments that are backed by the results of research and development. Specific areas of innovation are identified, (sometimes referred to herein as Targeted Areas for Innovation of “TAFI”). Examples include, but are not limited to (in vivo molecular monitor devices, adaptive mobile device signaling protocols, millimeter wide graphene sheet manufacturing etc.)

Automated apparatus and processes are utilized to generate an opportunity potential for a proposed TAFI. Opportunity potential may be assessed according to financial return or according to a non-financial goal, such as, for example, harvesting energy in a manner ecologically neutral.

An investor may invest in development of a Targeted Area For Innovation, by methods including the creation, management and offering of specialized financial products associated with TAFIs. An investor may purchase a financial product, such as a PondBond that is issued by a Special Purpose Entity (“SPE”) and thereby participate in financial and philanthropic results of the development. The SPE will typically have a security interest in IP associated with the TAFI and operate under charter and by-laws enabling the SPE to trade on an ARDI. Investment is facilitated by the creation of a Special Purpose Entity with a charter and by-laws specifying a purpose for the legal entity, including, by way of non-limiting example, area of scientific and technological development, well defined budget, types of intellectual property to be generated, timelines, term of the SPE existence, well defined monetization plans for the intellectual property, well defined IP transfer and licensing rights, financial management of invested funds and disbursement of revenues and other related information that protect PondBond investor security interests in the IP and their return on investment.

Essentially, once a TAFI SPE is created and at least partially funded, a search and hiring of IP experts is conducted. In some embodiments the search will be focused on university talent and physical resources. Other embodiments may include resources available via not for profit research organizations and/or for profit entities, such as corporate entities and start up entities.

Once an appropriate expertise is located and engaged, SPE management facilitates the generation of intellectual property by the resources engaged. Generation of Intellectual Property will include organization and harvesting of patentable subject matter, registration of computer code, registration of copyrightable works of art, documentation of know-how, maintenance of trade secrets and proper assignment of quantified IP. By approaching the business process of maximizing the value of innovation with long term funding of integrated management, an entire suite of IP, not just associated patents may be enhanced in value. A Targeted Industry For Innovation (TIFI) may be created by coupling this process for any one TAFI into a group of patents in a same overall industry or in purposefully disparate industries.

Given a TIFI may include a quantity of a handful to dozens of TAFIs, the present invention provides for the creation of a financial instrument such as an Exchange Traded Fund (ETF) that provides a risk mitigation strategy to investors interested in early stage assets that have value that may not be realized for years, or even a decade, and at the same time the investor may be provided the freedom of trading and liquidity that an ETF may offer.

The present invention provides financial vehicles for funding very early stage advancement in science and technology IP development while relieving innovative technically skilled people involved from attempting to develop associated IP assets. The present invention provides methods an apparatus for development of IP assets beyond original insights Skilled specialists are funded and specifically associated with projects to develop the unique business of IP patent advancement, such as, for example, claims development, prior art research, thicket analysis, portfolio planning and market analysis and prescience.

In addition, the present invention may provide for IP administration, IP business development and IP marketing functions with specialists dedicated and compensated to work with inventors and organizations. Business cases are developed and quantified for next stage investors to access in order to bring resulting innovations to the marketplace. .

In other aspect of the present invention, risk/reward of a single innovative area may be mitigated via the formation and management of funds with a Net Asset Value based upon multiple underlying innovative areas.

Embodiments include a computer server to implement the above methods via executable software stored on the server. If desired, the executable software may be executed on demand via the network access device over a communications network. A network access device will typically be an electronic device such as a computer or a wireless computing device, which may include one or more of wireless, mobile and cellular linked tablets, smart phones and flat panel digital or projection display devices. Devices may conform to the transmission control protocol/internet protocol, cellular protocol or other communication protocol.

Additionally the present invention may include a WEB interface for accessing the executable software stored on the server storage medium, or a method of interacting with a graphical user interface so as to facilitate a financial investment utilizing the above methodologies.

Still other embodiments include computer executable program code residing on a computer-readable medium or a computer data signal embodied in a digital data stream.

One general aspect includes an automated trading apparatus for improving market access and liquidity for targeted areas of innovation, the apparatus including: a computer server accessible with a network access device via a digital communications network, said computer server including a processor and a digital storage; and executable software stored on the digital storage and executable on demand, the software operative with the computer server to cause the apparatus to: receive data descriptive of an innovative technology; categorize the data descriptive of the innovation technology into a targeted area of innovation; receive data descriptive of an investment vehicle supporting development of the targeted area of innovation; transmit a graphical user interface to the network access device via the communications network, where the graphical user interface includes details of the targeted area of innovation and the investment vehicle and the graphical user interface may be transformed into a human readable format and receive input from a human; associate the network access device with an investor; receive an instruction from the network access device to make an investment in the investment vehicle on behalf of the investor and according to specific investment conditions; and generate an instruction to execute a transaction based upon the instruction received from the network access device.

Implementations may include one or more of the following features. The automated trading apparatus where the software is additionally operative to cause the apparatus to model an expected return on investment for the investment vehicle supporting development of the targeted area of innovation. The automated trading apparatus where the software is additionally operative to cause the apparatus to complete steps to: receive an investment objective from the investment vehicle supporting development of the targeted area of innovation, and calculate a determination indicative of a likelihood of the investment vehicle's fulfilling the objective. The automated trading apparatus where the software is additionally operative to cause the apparatus to: present a list of targeted areas of innovation associated with a particular investment vehicle; structure repayment terms for an investment in a targeted area of innovation on the list, where the repayment terms are conditional upon financial performance of the investment vehicle; and receive an instruction to invest in one or more of the targeted areas of innovation presented on the list according to the structured terms. The automated trading apparatus where investment is made in all targeted areas of innovation on the list. The automated trading apparatus where the investment vehicle is a limited liability company. The automated trading apparatus where the software is additionally operative to cause the apparatus to: create a contract to receive an amount of money related to technological success of a targeted area of innovation future, where the contract specifies one or more conditions of technological success; store terms of the contract on the computer server; and transmit over the communications network the terms of the contract to network access device associated with an investor. The automated trading apparatus where the software is additionally operative to receive an instruction via the communication network to purchase the contract. The automated trading apparatus where the software is additionally operative to: calculate a value for an option to purchase the contract relating to a value associated with the targeted area of innovation, transmit the value for an option to the network access device via the communications network, and receive a communication including an instruction to purchase of the option. The automated trading apparatus where investment is made on behalf of an underlying investment vehicle. The automated trading apparatus where the software is additionally operative to cause the apparatus to track a membership interest in the underlying investment vehicle commensurate with a capital contribution to the underlying investment vehicle. The automated trading apparatus where the underlying investment vehicle is a charitable lead annuity trust. The automated trading apparatus where the software is additionally operative to cause the apparatus to track distribution of funds to a predetermined beneficiary upon expiration of a lead term of the charitable lead annuity trust. The apparatus where the network access device includes a wireless mobile device. The apparatus where the computer communication network conforms to a transmission control protocol/internet protocol. The apparatus where the computer communication network includes the internet. The apparatus where the investment vehicle includes a pondbond. The apparatus where the investment vehicle includes an exchange traded fund. The apparatus where the investment vehicle includes special purpose vehicle. The apparatus where the software is additionally operative to receive an indication of receipt of a payment of an ongoing financial obligation related to investment in the investment vehicle.

The details of one or more embodiments of the invention are set forth in the accompanying drawings and the description below. Implementations may provide advantages such as supplemented funding for students attending a learning institution or supplemented funding of principals involved in a business venture. Other features, objects, and advantages of the invention will be apparent from the description, the drawings and the claims.

### DESCRIPTION OF THE DRAWINGS

FIGS. 1A-1C illustrate block components that may be utilized to implement the present invention.

FIGS. 2A-2C illustrate exemplary flows of method steps that may be used in some implementations of the present invention.

FIG. 3 illustrates a network embodiment of the present invention.

FIG. 4 illustrates a user interface with functionality that may be included in the present invention.

### DETAILED DESCRIPTION

The present invention includes a computerized method and system for facilitating and/or brokering investment in a Targeted Area for Innovation (“TAFI”). It some aspects it provides a financial analysis product for modeling an expected return on investment made in a TAFI based upon historical, market, demographic and other related data wherein the return on the investment is commensurate with the success of the TAFI. In addition, the present invention may create a portfolio of potential TAFIs such that an investment may be made in the aggregate of TAFIs included in the portfolio, and a return on investment may be received based upon the performance of the portfolio aggregate.

Qualifications that are considered desirable for a TAFI may be rated according to standardized terms or be highly subjective and specifically tailored to an individual technology. Similarly, technology related contracts may be generated which contain standardized terms and conditions or with terms that address specific needs and/or interests of a TAFI investor 102-106, TAFI, educational institution, charitable institution, philanthropic entity, investment facilitator, broker or other party related to the renewable technology process. Generally, terms of a technology contract provide for a TAFI to receive funding in the near term in order to pursue an educational endeavor in return for a covenant to perform a specified action at a later date. The action may include for example sharing future earnings or net worth.

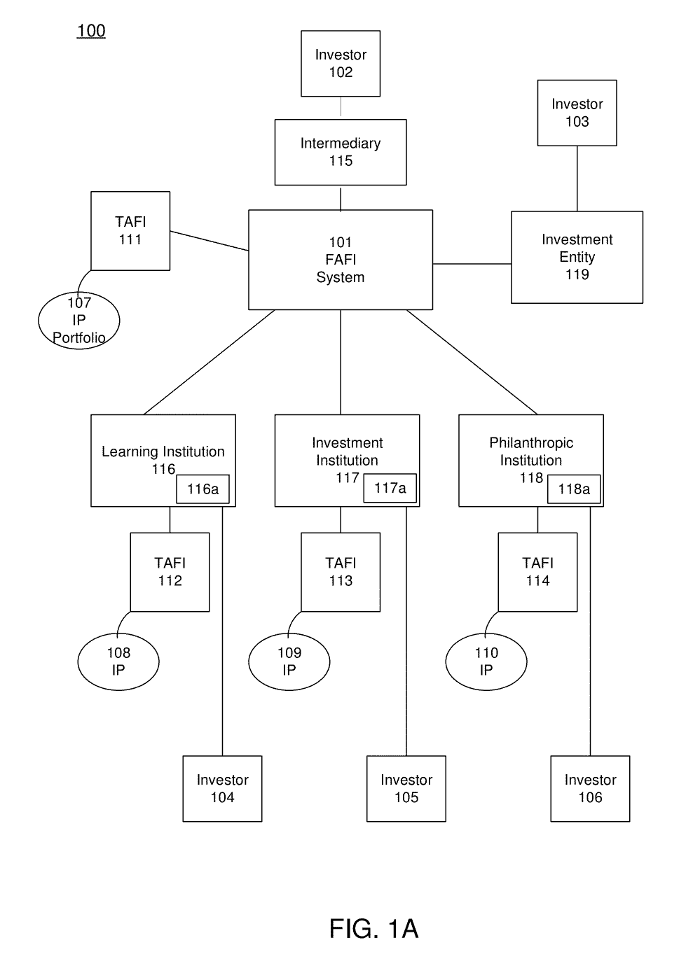

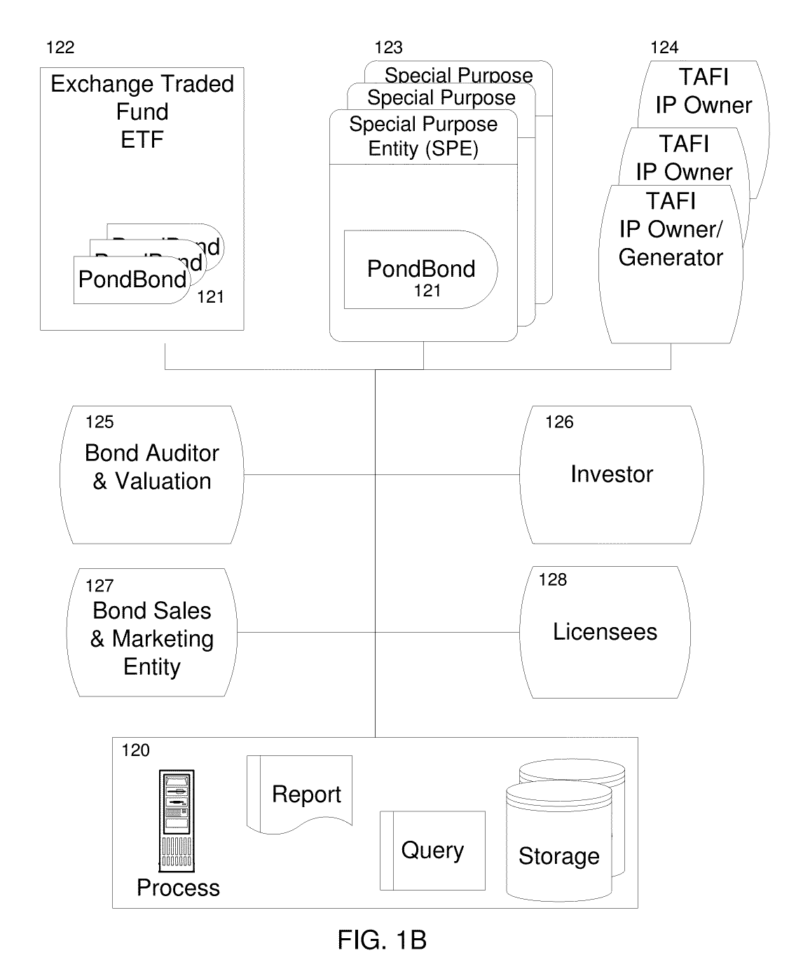

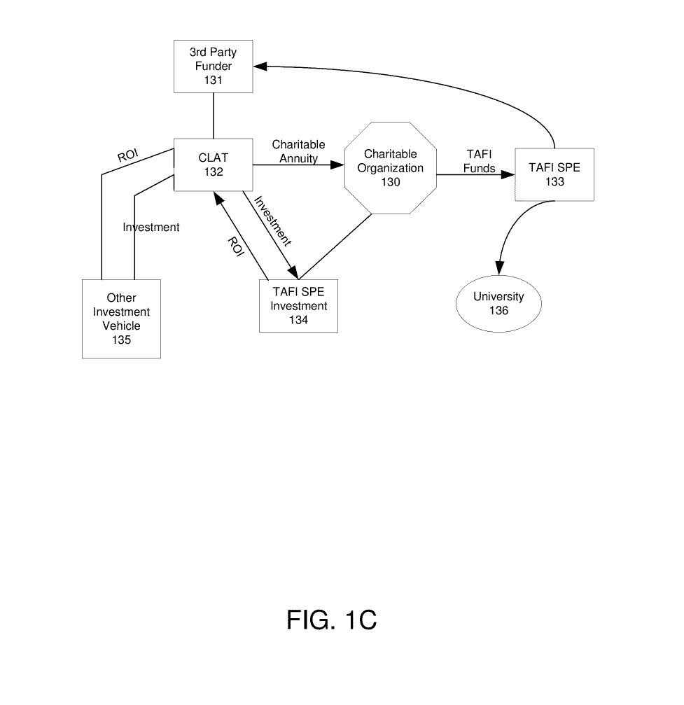

Referring now to FIG. 1A, a block diagram 100 is illustrated representing major components involved in the present invention for investment in one or more TAFIs and modeling a TAFI SPE according to goals supported by investment, scientific, technological, philanthropic and/or charitable motives. A Financial Administration for Innovation System (“FAFI System”) 101 may receive objectives of a TAFI and model expected results from investment in a specific TAFI or set group of TAFIs and determine whether such investment is suited to meet one or more objectives of a TAFI investor 102-106. A TAFI investor's 102-106 one or more objectives may include for example, philanthropic motive, political purpose, religious purpose, income generation, or obligation to a technology system. Alternatively, an FAFI System 101 may receive objectives of a TAFI 111-114 and model results a SPE sponsoring the TAFI 111-114 may expect if the SPE enters is formed to develop the proposed objectives.

In some embodiments of the present invention may include a fund or instrument that is based upon the financial results of multiple TAFIs. The fund may generally be viewed as a “mutual fund” that mitigates risk/reward of single TAFIs across multiple TAFI' s. The fund or instrument may be referred to as a TIFI (Targeted Industry For Innovation). As discussed further below, a TIFI may be created with a value based upon the PondBonds that are administered in multi TAFI SPEs. In some embodiments, the value attributed to each TAFI is weighted equally, in other embodiments; some TAFIs may be associated with a weighted value higher or lower than other TAFIs.

The FAFI System 101 acts as a vehicle to facilitate the exchange of information between TAFIs 111-114, TAFI investor 102-106, institutions 116-118 and/or a technology facilitator 116a-118a. In addition, the FAFI System 101 may act as an exchange or other vehicle for the execution of a technology investment transaction. Qualifications descriptive of a TAFI's 111-114 attributes and/or accomplishments are input into the FAFI System 101.

Qualifications descriptive of a TAFI's 111-114 may include, for example, area of innovation, possible applications of innovation, projected markets for innovation, projected pricing of the innovation as a standalone offering or incremental enhancement or component of an existing offering, projected social impact of an innovation, expected philanthropic impact of an innovation, projected environmental impact of an innovation, experience of researchers, prior accomplishments of a TAFI 111-114 research team, is admitted or other information indicative of the character, potential value or capability of a single invention or set of inventions in a TAFI 111-114.

The qualifications are preferably input as electronic data. However, informational data comprising electronic records, electronic data files, hardcopy documents, oral interviews or other sources may also be received, scanned, transcribed or otherwise input into the FAFI System 101. Images of hard copy documents may be viewed or transmitted, such as by email, streamed, links to document repositories. In some embodiments, a TAFI 111-114 may present qualifications to a learning institution 116, investment institution 117, philanthropic institution 118 or any other intermediary 115, such that the intermediary will input the qualifications to the FAFI System 101.

In some embodiments, an Intermediary 115-118 may also be involved in brokering or otherwise advancing investment in a TAFI 111-114. Intermediaries 115-118 may take many forms including a hedge fund, a bond broker, an exchange, a financial advisor, an educational institution office of technology transfer (“OTL”), a technology “broker”, a corporate licensing executive, an independent consultant, a governmental organization such as a licensing agency or trade commission representative or one of many authoritative bodies around the world, one or more potential researchers or a proponent of a particular cause. Typically, an intermediary 115-118 will present qualifications of a TAFI 111-114 in a manner that addresses an intermediary's 115 agenda. For example, a technology broker intermediary 115-118 may receive a fee for each technology contract brokered. In order to maximize interest in investing in technologies, the broker may present qualifications according to the likelihood of financial success. Another Intermediary 115-118 may seek to promote a humanitarian, environmental or artistic agenda, an agenda of, or pertaining to a trending topic, an agenda that is desirous to a particular group of people, and present qualifications of a TAFI 111-114 according to a likelihood of the TAFI 111-114 promoting such an agenda.

The FAFI System 101 may store and organize TAFI 111-114 qualifications as electronic data which may be presented to a TAFI investor 102-106 to facilitate investment in a TAFI 111-114. Presentation to the TAFI investor 102-106 may include an offer with terms under which a TAFI investors 102-106 may invest in a TAFI 111-114. In some preferred embodiments, a TAFI investor 102-106 may accept an offer for investment in a technology for a particular TAFI 111-114 or group of TAFIs 111-114 and a technology contract may be executed with a digital signature or other electronic mechanism for creating a legally binding artifact. In some embodiments, a standardized instrument, such as a bond or other financial instrument may also quantify investment. A corresponding TAFI 111-114 may also be made a party to the technology contract in a similar fashion. The technology contract may be embodied in a hardcopy document and/or by electronic means.

Different scenarios may allow for a TAFI investor 102-106 to make an offer which a TAFI 111-114 may accept, such as with an electronic signature or authorization code. Alternatively, the TAFI 111-114 may first put forth acceptable terms of investment that constitute a legally binding offer which a TAFI investor 102-106 may accept. If necessary, multiple iterations of offer and counter offer may take place before an investment agreement is reached.

In order to facilitate the investment process, an investor may arrange for a pre-authorized line of credit. One credit arrangement may include a credit line collateralized by another asset. A collateralized line of credit allows success in a first TAFI SPE investment to be used as collateral to allow the investor to invest in one or more additional TAFI SPEs. Assets may also be leveraged if desired. Other credit arrangements may include charging a line of credit, on online payment transfer account, electronic remittance, a credit card or debit card.

A TAFI investor 102-106 may include an individual or institution that seeks a profitable return on investment and/or that seeks to fulfill a philanthropic motive. The FAFI System 101 may offer a unique ability to perpetuate a contribution designed to promote a particular endeavor. In addition a TAFI investor 102-106 may include an individual or institution who decides to invest in the future of an innovation area or group of innovation areas as opposed to the future of a corporate entity, a government entity, a business, a commodity, or other currently available structured investments.

In some embodiments, according to applicable laws and regulations, and perhaps according to a size of a TAFI investment and/or the structure of the TAFI investment, a TAFI investor 102-106 may be required to be a qualified investor according to Securities Exchange Commission guidelines.

Return on an investment in a TAFI 111-114 may be based upon monetization of IP 108-110 generated or acquired by a TAFI 111-114. Monetization may include, by way of non-limiting example, one or more of: license of IP, sale of IP, merging a SPE with one or more other SPEs or other entity, government funding of a SPE and other vehicles for receiving revenue.

In some embodiments, an investor may invest in a TAFI in order to facilitate advancement of a philanthropic endeavor. Advancement of a philanthropic endeavor may include, for example, accomplishment of an innovative goal that benefits society, a positive environmental impact, alleviation of a medical condition, increase in wellness of a population, enhanced human capability, enhanced food production capability, improved water quality, improved educational systems, advancement of social interactions, work towards world peace, or other objective a TAFI investor 102-106 may wish to promote.

Terms of a technology contract may vary according to the agenda held by each party and the relative bargaining position of each party. The terms may include almost any other exchange of value and are not limited to a portion of a TAFI 111-114 based revenues. For example, terms of a technology contract may require that a TAFI 111-114 be responsible for making available IP available to another endeavor for a defined fee. This example may be particularly useful in the case where a TAFI 111-114 is related to a published operational standard adopted by an industry standards organization.

A TAFI 111-114 possessing attributes which are in demand by TAFI investors 102-106 may be able to attract multiple offers from TAFI investors 102-106 willing to invest in the TAFI's 111-114 future. With multiple offers available, the TAFI 111-114 may be able to negotiate terms of a technology contract, or other Investment Product arranged by the FAFI System 101 , that are more favorable to the TAFI 111-114.

A TAFI 111-114 possessing more generic attributes may be able to attract investment, but may have to agree to terms that are more strenuous. These terms may include a greater percentage of future earnings, specific performance of non-income related conditions, or other terms that are designed to meet a TAFI investor's 102-106 agenda. In one embodiment each contract may have terms and conditions that are tailored to a specific situation at hand and specifically address the investment goals of the TAFI investor 102-106 as well as SPE objectives associated with a related TAFI 111-114.

In another aspect, an FAFI System 101 may provide a scaled rating indicative of a degree of confidence in a TAFI's 111-114 likelihood of success. A highest degree of confidence may correspond with a high rating, such as an A+ rating or a 100 rating. Additional degrees of confidence may be indicative of incrementally diminishing confidence in the TAFI's 111-114 likelihood of success. Other rating scales may also be utilized as provided by an independent Bond Rating Agency that develops scoring mechanisms based on asset value of IP and expected value of future licensing cash flows.

A TAFI confidence rating may be based upon objective or subjective data. Objective data might include test scores, academic accomplishments, entrepreneurial success, participation of a learning institution with a promising reputation, pursuit of a high income technology area, and any other quantifiable data describing a TAFI 111-114, the TAFI's 111-114 documented innovation goals.

Subjective data may include a TAFI investor's 102-106 or other rating person's intuitions about a TAFI's PondBond 111-114 prospects. Subjective intuitions may be fostered by market analysis reports, market conditions reports, geo-political variables, demographics, an interview, written materials submitted by the TAFI 111-114, qualities or talent of persons involved in a SPE associated with a TAFI 111-114. In some embodiments professional raters trained to analyze a TAFI 111-114, provide input to be utilized to calculate a confidence rating.

Qualifications utilized to calculate a confidence rating, or independently utilized by a TAFI investor 102-106, may include the reputation of an educational institution that a TAFI 111-114 will developed by, reputation of a company or individual professor or professors lab or multi university consortium lab that a TAFI 111-114 will developed by the TAFI's 111-114 achievement record of those endorsing a TAFI 111-114, activities the TAFI 111-114 engages in, past experience, expertise, market data, past accomplishments and almost any other data related to a TAFI 111-114 or investment objective.

Analysis may include market data quantifying the types of projects and innovations similar qualifications and potential market impact, average compensation for monetization of similar innovation areas, data relating to a particular field of endeavor entered into by a TAFI 111-114. In addition, external market conditions such as an indicator descriptive of the national economic condition, market strength of an industry, interest rates, inflation, demand for a chosen field or other general data may also be utilized to conduct analysis.

In some embodiments, the present invention includes a FAFI System 101 that recognizes that TAFI investors 102-106 are motivated by various things which may include a monetary return or other form of satisfaction, such as furthering a worthy endeavor, such as for example a measurement of additional children drinking clean water which is then turned into specific remuneration by another charitable organization with long term commercial licensing of the IP perhaps years further down the road. Accordingly the FAFI System 101 may also combine projected returns from a TAFI's 111-114 intended innovation objectives with the benefactor pursuits and/or value system of the investor and make a determination regarding the future satisfaction and benefit that investor may be received for sponsoring a TAFI 111-114.

In some embodiments, a confidence rating is calculated with success criteria which are quantified and weighted according to relative importance. A value is calculated for each criterion that pertains to a TAFI 111-114 according to data received descriptive of attributes of the TAFI 111-114. The criteria value is multiplied by the weight assigned to each criterion to calculate a criteria score. Each criteria score is added together such that an aggregate sum of the criteria scores may be calculated to equal a confidence rating.

Standardized technology contracts, such as a bond offering or other financial instrument, which may be associated with a confidence rating, may also be utilized to facilitate an automated technology investment process. A series of standardized technology contracts may capture investment terms representing a graduated scale of favorability, similar to the confidence rating. At one end of the scale, the terms of the contract may be written to reflect great confidence in the future of a TAFI 111-114.

At the other end of the scale, terms may indicate a more moderate, or even negative view of a TAFI's 111-114 future. Terms reflecting moderate interest in investment will most likely indicate some measure of confidence by the TAFI Investor 102-106 in the TAFI's 111-114 ability to succeed. Following this example, a technology contract corresponding with a low confidence rating may contain terms that are most strenuous on the TAFI 111-114. However, even a technology bond corresponding with a low confidence rating will enable a TAFI 111-114 to pursue a research objective that might otherwise be unavailable to the TAFI SPE 111-114.

Technology contracts may also have different classifications or levels indicative of the relative bargaining power of a TAFI investor 102-106 and a TAFI 111-114. As mentioned above, contract levels may correlate with a confidence rating in a TAFI 111-114. Each contract level may be indicative of standard underlying terms and conditions. Standardization may be useful in that both parties may be assured as to the terms they are entering into without undue analysis, such as review by an attorney. Research and commentary relating to the terms contained in contracts associated with various levels may be circulated such that parties entering into a particular contract may be better educated as to their expectations regarding such a commitment.

For example, a series of contracts may quantify an arrangement whereby, in return for money invested in the TAFI's PondBond 111-114 an investor may be entitled to be reimbursed on a preferred basis from first revenues received from monetization activities. In addition, a TAFI 111-114 may agree to pay a predetermined set percentage or a variable percentage of the TAFI's 111-114 revenue for a term of years once monetization efforts commence. A TAFI's increased revenue generation capacity as development of the innovation matures thereby benefits both the institution conducting the IP generation 121-123 and the TAFI investor 102-106 who funded the TAFI 111-114. One embodiment may include a variable percentage of a TAFI's revenue generation during a payback term. The percent of revenue generation may be determined by a range for the TAFI SPE during a particular year, according to a time period of pay out, be front or back end weighted, or according to some other schema.

In another aspect, an “A” rated bond or other designation for a highly rated bond or other financial instrument may call for 10% of a TAFI SPE revenue for a period of eight years, while a “B” level or other secondary rated instrument may require a payback of 15% for a period of ten years.

TAFI based financial instruments may also call for a pay-back period to commence upon a triggering event, which may include, for example, development of a prototype, consummation of a license agreement, a threshold amount of sales of a product embodying a targeted innovation, or other criteria. Typically, a TAFI 111-114 that demonstrates a high probability of success will be able to negotiate either a lower percentage of revenues, shorter term of pay back years and/or other terms favorable to that TAFI 111-114.

Standardized bonds or contracts assembled as a TIFI into an ETF will also facilitate the creation and maintenance of a liquid market for contracts at various states of maturity. A TAFI investor 102-106 who has obtained a PondBond early in a TAFI's 111-114 life cycle may have the option to later market the PondBond or contract. Preferably, an exchange will list available technology bonds as well as market data related to the sale of technology bonds or other instrument. PondBonds may increase or decrease in value depending upon the performance of a correlating TAFI 111-114, or group of TAFIs. In addition, market data may affect the value of an investment. In a strong economy, the value of an investment and correlating technology contract associated with a particular industry or academic pursuit may be valued relatively high, while a weak or receding economy may be more beneficial to other sectors or curriculum. Other factors may also affect the market value for a particular bond, contract or pool of bond or contracts or instrument based upon TAFI 111-114 value.

A financial model based upon the present invention may include expected returns based upon an analysis of qualifications of an individual TAFI 111-114 or upon an aggregate of TAFIs associated in a portfolio or “mutual fund” of TAFIs. Data considered in the analysis may include TAFI 111-114 qualifications and marketable talents as well as stated objectives of the participants.

In some embodiments, the computer model generated by the FAFI System 101, or other computer, may systematize analysis for multiple participants with various qualifications and backgrounds. Amongst other functions, analysis may include grouping multiple TAFIs 111-114 together in order to create a hedge or otherwise diminish risk associated with investing solely in any one particular TAFI PondBond investment. In one example, a group of TAFIs with similar attributes may be formed into a portfolio. In this case, investment in the portfolio may reflect a particular market segment and yet be insulated from the peculiarities that may be associated with a specific TAFI 111-114. Hedging may also be conducted across industries or sectors, according to technologies, across chosen learning institutions, amongst various market types or any other combination of factors. In addition, hedging may be utilized within a homogeneous group of TAFIs 111-114, whereby risk is not associated so much with an individual TAFI 111-114, but with a group of TAFIs with similar attributes. Analysis of a hedged group may include expected return on investment, likelihood of success in achieving a particular goal, quantification of a particular need, or other inquiry.

Accordingly, TAFIs may be grouped together to form a portfolio for investment, thereby forming a “mutual fund” of investment opportunity in TIFIs. A TAFI 111-114 portfolio (sometimes referred to herein as a “TIFI”) may be created to address various investment criteria, such as those listed above for analysis. For example, a TIFI may be created to invest or promote a particular industry or cause without being limited to one TAFI or a TIFI may be created that includes multiple diverse industries and technology to further diversify risk associated with a TIFI.

A portfolio may also be designed to meet criteria specified by a donor or TAFI investor 102-106. Specified criteria may include almost any ascertainable purpose or data. Some examples of specified criteria may include: TAFIs with a specific intended purpose, such as environmental benefit, recipient of an award or other designation; TAFIs obtaining a minimal revenue generation, TAFIs with a particular science area, TAFIs with researchers pursuing a specific educational curriculum, TAFIs with researchers from a particular geographic area, or any other criteria that may satisfy a personal, social, religious or philanthropic motive of a donor or TAFI investor 102-106.

The FAFI System 101 may also receive as input, a technology investment objective put forth by a TAFI investor 102-106 or group of TAFI investors 102-106. The FAFI System 101 may model one or more financial structures through which the objective may be fulfilled. In addition, financial structures may combine investment objectives with market data and model suggested investments. Market data may include information relating to educational institutions, demographics, personal attributes of researchers or fund managers, economic trends, market data and other data that relates to potential returns or personal objectives. The FAFI System 101 may calculate expected cash flow and other financial benefits based upon market data. A financial investment structure modeled by the FAFI System 101 may include factors pertaining to a specific individual, a learning institution, a demographic group or other criteria.

A TAFI investor 102-106 may have multifaceted objectives for a potential investment. For example, a TAFI investor's 102-106 objectives may include a philanthropic motive, political purpose, income generation, fulfillment of an obligation to a technology system, a targeted return on investment, charitable intent, tax planning and/or estate planning, or other objective. The FAFI System 101 may execute a transaction causing an investment to be made in one or more TAFIs that indicate a propensity for fulfilling some combination of the objectives and track progression of the investment through a term of years. In addition, actual technology investment experience may be utilized to further refine subsequent models of financial structures.

A negative view of the future of a TAFI with specific attributes may be represented by an option that reflects a decreasing value for a contract that captures the TAFI's 111-114 future earnings for a term of years. In essence, an option may sell short the contract on the TAFI's 111-114 future.

Another embodiment of the present invention may include an alternative to a TIFI wherein an investor may purchase or otherwise acquire an interest in an investment entity 119, such as a limited liability company (LLC). The investment entity 119 may be utilized to make one or more investments in one or more TAFIs. If desired, the investment entity 119 may also be a single member investment entity 119 formed on behalf of the TAFI investor 102-106. For the purposes of this invention, an LLC may be an unincorporated organization that provides limited liability to its members, regardless of the extent of their participation in the management of the LLC. Advantages of investing through an LLC may include protection for a TAFI investor 102-106 as a member of the LLC. In their capacity as members of the LLC, the TAFI investors may not be personally liable for the debts, obligations or liabilities of the LLC, except to the extent the members agree to be personally liable pursuant to an agreement and except that members may be obligated to repay any amounts wrongfully distributed to them. Absent an affirmative election to treat a single member LLC as an association taxable as a corporation, a single member LLC may presently be treated as a disregarded entity for federal income tax purposes (i.e., as a sole proprietorship if owned by an individual). Other legal organizations with similar or different advantages may also be utilized as an investment entity 119.

Referring now to FIG. 1C, in some embodiments, an investment vehicle may make a charitable donation in the form of a TAFI Investment 134 to a Charitable Organization 130 and TAFI Funds may be directed to a TAFI SPE 133. The TAFI SPE 133 may be associated with a University 136. The investment vehicle 135 or other investor may treat the Charitable donation as a simple donation, or it may receive an eventual payout on the investment, in which case the payout may be a taxable event. In addition, a payout may be directed to a person or entity other than the Investment Vehicle 135.

In some particular exemplary embodiments, an investment entity may include a charitable lead annuity trust (CLAT) 132 which is utilized to meet investment objectives of a TAFI investor and also provide for investment in a TAFI. A CLAT 132 is a legal entity which may be established for a fixed number of years (the “Lead Term”), with a fixed amount being paid to a charity (the “Charitable Lead Annuity”), during that period. A TAFI investor that makes use of a CLAT 132 may receive a charitable gift tax deduction for transfer tax purposes. In some embodiments, the charitable transfer tax deduction may be valued at up to 60% of an initial asset used to fund the CLAT 132. A charitable gift may be valued at the present value of a charitable lead annuity payment during a Lead Term, as computed according to IRS guidelines. A TAFI investor may utilize lifetime estate and transfer tax credits, or pay transfer tax, on the remaining initial value used to fund the CLAT.

An investment entity manager may manage investments in TAFIs included in the CLAT. In some embodiments, an investment entity manager may act under authority of an investment contract. Under the terms of the investment contract, the investment entity manager may invest capital contributed by an investment entity 119 jointly and severally with the capital of one or more other investment entities. Each investment entity may then own an undivided, fractional interest in TAFI SPE investments and pay its proportionate share of capital calls, technologies or other costs. In turn, each investment entity 119 may receive its proportionate share of the proceeds in the form of cash flow and other benefits as well as income tax attributes from donations to charitable organizations. In another embodiment, all capital received from one investment entity 119 may be fully segregated and invested separately from capital received from any other investment entity 119.

Referring now to FIG. 1B, in general, a FAFI system 120 acts as a conduit for information and transactions between entities 122-128 involved in generation of PondBonds with a pecuniary value based upon one or more TAFIs. In some embodiments, a FAFI system 120 may include automated apparatus (as described further below) for processing data, including generating, receiving, and manipulating digital data. The FAFI system 120 may receive and respond to queries, generate reports, transmit data including responses to queries and reports, receive data on TAFIs, generate projections related to TAFIs, calculate and transmit financials, track TAFI progress, track subject areas related to TAFIs, and other related data processing.

A TAFI IP Owner/Generator 124 may receive funding or other pecuniary compensation for dedication of TAFI related intellectual property to a SPE 123. The TAFI IP Owner/Generator 124 may simply own intellectual property, or may be a research facility, such as a university that generates intellectual property on an ongoing basis. In some cases, the IP Owner/Generator 124 will receive funding to specifically conduct research and generate intellectual property.

Quantification of intellectual property is typically coordinated by a SPE 123 in a contractual relationship with the TAFUI IP Owner/Generator 124. In some preferred embodiments a PondBond funded SPE 123 will be organized specifically to facilitate the generation and aggregation of intellectual property related to a specified TAFI. The SPE will receive funding via the issuance of PondBonds 121 and act according to a charter that calls for the generation and/or aggregation of intellectual property and other business development activities related specifically to the TAFI.

In some embodiments, a SPE will coordinate development of IP on a worldwide basis and not limited to any one time zone work day. A SPE may coordinate SolarShift IP development/quantification wherein an IP generation effort is accomplished via an accelerating workflow of standardized workday processes in a rate that is 300% faster than normal. When an IP generation/quantification process is assigned under a SolarShift, a recipient is required to complete their work within their respective 8 hour period and post it on a global server. The next recipient designated in the workflow process may then access the delivered work at the end of the first persons shift and so on. In this way 3 different 8 hour shifts of work are accomplished following the sun and delivering 3 complete workdays in one 24 hour period.

In a further aspect of the present invention, in some embodiments, a PondBond exchange traded fund (ETF) 122 will aggregate multiple PondBonds and generate and trade securities based upon the value of aggregated PondBonds 121. The PondBond ETF 122 will trade securities based upon the fund assets in a similar manner as other ETF trade securities with a value based upon stock, bond, asset class or other collection of valuable financial instruments held by the fund. In the present invention, the value of the ETF securities will track according to the value of aggregated SPEs. SPEs in turn will derive their value based upon development of the TAFIs on which the value of PondBonds held by the ETF. PondBond 121 value will be based upon history or future expected monetization of TAFI intellectual property. Unlike stock based ETF's a PondBond based ETF may limit exposure to debt my only including SPEs that are precluded in the charter from assuming debt that would impair the value of the fund.

A PondBond based security that tracks an index, a commodity or a basket of assets like an index fund, but trades like a stock on an exchange. ETFs experience price changes throughout the day as they are bought and sold. By owning an ETF, the investor enjoys minimization of risk by the diversification of an index fund as well as the ability to sell short, buy on margin and purchase as little as one share. A PondBond based ETFs will track the value of PondBonds included in the PondBond ETF in a similar way that, for example, the Spider ETF (SPDR), which tracks the S&P 500 index and trades under the symbol SPY.

The SPE will monitor research progress and work with the TAFI IP Owner/Generator to file patent portfolios, memorialize know-how and trade secrets, protect copyrightable works, including any related computer code and the like. The SPE will also receive investment monies from the issuance of PondBonds. The PondBonds 121 have a value based upon TAFI core assets of collective IP in the various individual SPEs. In some embodiments, the PondBond 121 will be collateralized by the TAFI IP.

A PondBond 121 will be marketed and sold by a Bond Sales and Marketing Entity 127. For example, a Bond Sales and Marketing Entity 127 may include a registered bond broker, wherein a bond broker is someone who is licensed or registered to buy and sell bonds for institutional or individual investors.

In still another aspect of the present invention, in some embodiments, a Bond Auditor 125 may also be engaged to audit and provide a valuation of a PondBond 121. The Bond Auditor 125 may review monetization efforts of underlying IP and the strength of IP Portfolios related to a designated TAFI. The Bond Auditor 125 may also ascertain that PSE funding has been correctly dispersed according to a SPE charter.

Funding for a SPE 123 may be derived from the issuance of PondBonds 121 which are purchased by an investor 126. An investor 126 may include an institutional investor or an individual investor. In addition, funding may be received into a SPE 123 via monetization efforts and the issuance of licenses to TAFI IP to Licensees 128. Licensee 128 may receive, by way of non-limiting example a license to one or more of: patents, know-how, trade secrets, trademarks and to copyrighted materials.

In some preferred embodiments, an investor 126 will purchase a PondBond and receive an interest rate return, which may be paid in periodic payments, such as annular payments, monthly payments or upon termination of the PondBond. In addition, the Investor 126 may receive a return of principal and a share of value realized by a SPE in monetization of TAFI IP.

In some embodiments, TAFI will have ownership rights transferred to an associated PondBond SPE 123. IN other embodiments, TAFI IP ownership will be retained by a TAFI IP Owner and exclusively licensed to the PondBond SPE 123.

Referring now again to FIG. 1C, in one embodiment a technology recipient's 133 obligation to return value to a TAFI investor may include formation of a CLAT 132 or other tax vehicle, which will invest in a charitable organization 130 that awards technologies, or otherwise benefits the TAFI investor. For example, a particular university 133 may have an affiliated charitable organization 130 that invests in TAFIs with research conducted at the university via a TAFI SPE 133. Terms contained in a SPE charter or an investment contract entered into by the affiliated charitable organization 133 may require subsequent value be rendered to the affiliated charitable organization 130 by the TAFI SPE 133. A CLAT funder 131 may provide funds to a CLAT 132 which provides value to the affiliated charitable organization 130 in the form of a cash donation, such as an annuity. The CLAT funder 131 receives associated tax benefits, including potential transfer tax benefits to the CLAT 132 beneficiary, as well as a potential upside from the CLAT 132 investing in the technology investment 134. The university 136 receives the research funds, and the TAFI SPE receives developed intellectual property.

Alternatively, an investor may make a straight donation to an affiliated charitable organization on behalf of a TAFI SPE 133 and participate in the terms of a technology contract offered to the TAFI SPE 133. Properly structured according to a present tax code, the investor may be able to receive a tax benefit for the initial donation, as well as a potential monetary payout to the investor or to a named beneficiary, if and when the TAFI SPE 133 generates revenue. The monetary payout may be subject to a tax consequence by the recipient. In still another alternative, the investor may be able to receive a tax benefit and direct a future obligation of IP generation or other intangible benefit on to a particular organization, either charitable or for profit.

The FAFI System 101 may model and track a TAFI investor's 102-106 technology related investments as well as a TAFI investor's 102-106 offerings, fees and other interests received in return for services. Payments may include, for example, standard fees such as a formation fee or a management fee and/or payments specific to a particular TAFI 111-114, such as an equity share in the TAFI's 111-114 future, a commission for an award of a technology, or a commission received as a percentage of a technology pay-back.

The FAFI System 101 may also model and track conveyance of a portion of an ownership interest associated with an investment entity 119, such as a Charitable Lead Trust or Charitable Lead Annuity Trust (CLAT) 132, organized for the TAFI investor 102. Cash flow generated by investment in a TAFI 111-114 or TAFI portfolio, or other benefit resultant to a CLAT 132 or other investment entity 119 ownership, may be distributed to a beneficiary in the form of an annual or other scheduled annuity. Cash flow in excess of a charitable lead annuity may be accumulated in an associated CLAT 132 or other favorable tax related vehicle. After a charitable obligation is satisfied, accumulated cash may be eligible to be distributed to designated heirs free of transfer tax.

If desired, a computerized FAFI System 101 may be used to model organization of TAFI 111-114 technology contracts such that the technology contracts are designed to meet specific predetermined investment, tax, and other criteria. For example, these criteria may pursue an investment in technology contracts which will have a yield sufficient to satisfy an annuity requirement for a CLAT 132, which is fixed from time to time by the Internal Revenue Service. The present invention's modeling and financial structuring capabilities may be used by a TAFI investor 102-106 to assist them in making certain investment and allocation decisions based on the TAFI investor's 102-106 individual estate, income tax, cash flow and charitable goals. The FAFI System 101 may display a description of proposed technology contracts; projected returns associated with the technology contracts and actual performance of the technology contracts.

One product embodying this invention may include a fractional share of a portfolio or basket of TAFI contracts. A portfolio of TAFI contracts may be set up as unit investment trust, a closed end trust or an open end fund. In an open end fund the total amount of shares outstanding within the trust may fluctuate daily according to investment interest. Investment in an open end fund may be made available an exchange, such as for example via an ETF exchange.

Another product embodying the present invention may include a security relating to a predetermined group of TAFI contracts and/or SPEs. A tradable security such as an Exchange Traded Fund may be created, for example, by investing assets in predetermined TAFI contracts that are all in a particular industry sector, which we have defined as a TIFI Targeted Industry for Innovation. If desired, TAFI contracts upon which a security is based may have a shared characteristic as being in the same general industry category. Alternatively, the TAFI contracts upon which a security is based may have dissimilar characteristics which may be utilized to create a hedging effect as per any particular characteristic. A security may include a closed end fund of TAFI contracts, which has a fixed number of shares outstanding, and a constant portfolio invested exclusively in a specified set of TAFI contracts. The result is a new security which will replicate the performance of those contracts purchased. This security may then be listed on a securities exchange and traded. After trading begins, linked derivative securities may also be listed and traded. In this manner, TAFI contracts, when securitized, may be listed on a stock exchange and traded at any second, minute or hour.

Still another embodiment may include creating a corporation wherein corporate assets include specific TAFI contracts. Shares in the corporation may be traded according to the value of the contracts held.

The invention may also act as a hedge for market makers who wish to lay off their risk of making markets in options on the underlying TAFI contracts. In addition, TAFI investors 102-106 are be able to leverage their investments and be able to place, open, stop loss, market, limit orders or other type of order when buying or selling TAFI contracts or portfolio funds of TAFI contracts. TAFI investor 102-106 may purchase or sell shares of securitized contract funds immediately by making a phone call to their broker, or by electronic trading. The securitized technology contract funds may have a fixed number of shares to provide stability of asset levels and TAFI investors 102-106 will be able to sell shares short quicker, and with greater liquidity.

The present invention includes the ability to trade a contract related to a TAFI's 111-114 future earnings or an index of securitized TAFI contracts with linked derivative products. TAFI investors 102-106 are able to own multiple portfolio funds of TAFI contracts in an effort to diversify their investment portfolios, much like a mutual fund of traditional securities. An index of TAFI contracts may allow greater diversification, lower transaction costs, expanded investment choices and the ability to measure TIFI contract fund performance against a relevant benchmark index. The index could be calculated many different ways with a great deal of flexibility: equal price weighted, capitalization weighted, or geometrically weighted, depending upon a specific need.

An electronic database of statistical information may be stored in a computer containing TAFI contract investment fund statistics that are registered in the defined country or geographic area. This database may include fund value for a given time period, portfolio composition, investment objective, load adjusted and unadjusted return, maximum sales charge, median market capitalization, daily, monthly, quarterly, yearly, multi-year returns, beta, sharpe, R squared, standard deviation, historical risk/reward ratios, distribution adjusted earning, payout ratio, potential capital gains exposure, price ratios, prospectus, purchase constraints, redemption fees, sector weighting, shareholder fees, total return, total return percentile, turnover ratio, deferred fees, manager name, manager tenure, class of shares, and brokerage availability. It will be understood that not all of this information is required to practice the claimed invention.

A computer program algorithm may be created responsive to a query by an interested party, such as a TAFI investor 102-106, or fund manager. The algorithm may act as a filter eliminating from a search all TAFI contracts that do not fit within the criteria and present a list of those TAFI contracts that do meet the criteria or store those contracts within a new section of the computer memory. A time period (t) for which statistics will be analyzed may also be specified. In addition, a TAFI contract or portfolio of contracts may be ranked based upon its performance over specific time periods.

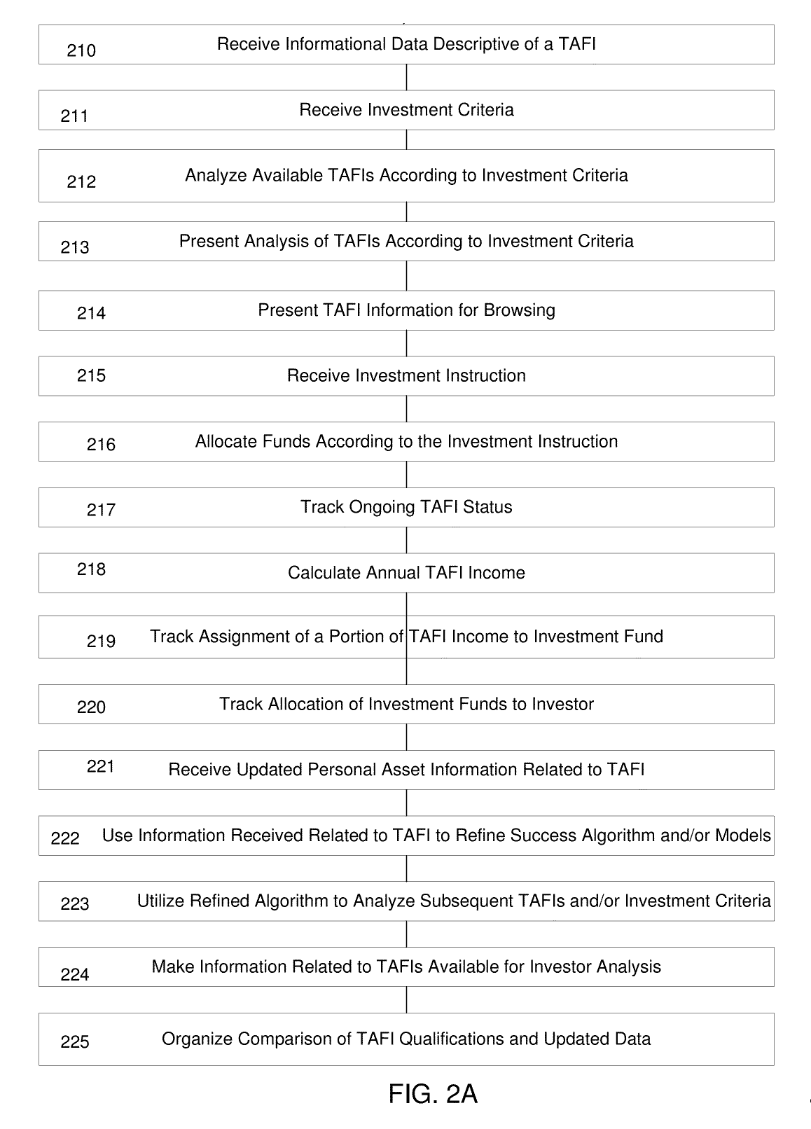

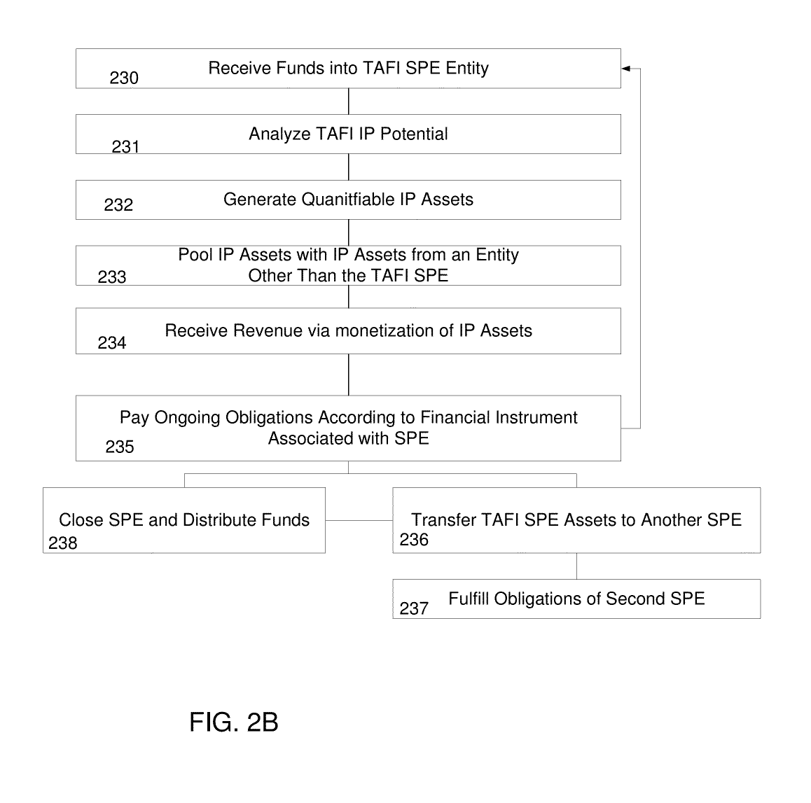

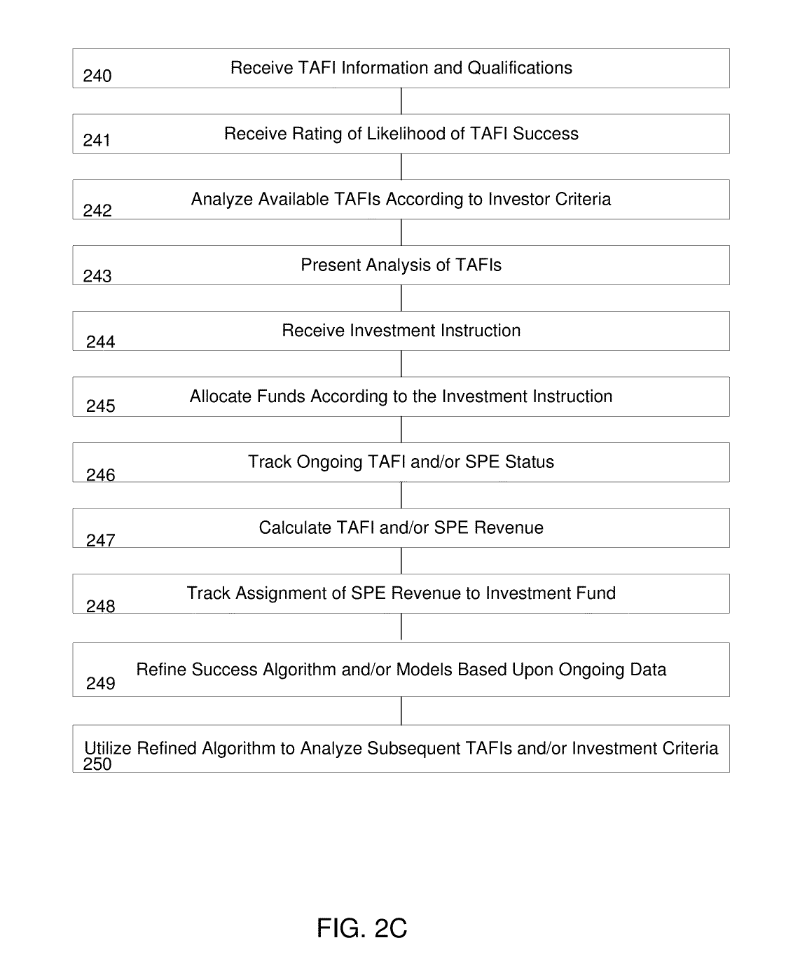

Referring now to FIG. 2A, a flow of an exemplary computerized process for providing automated TAFI investment is illustrated. At 210 the FAFI System 101 may receive informational data descriptive of a TAFI and the TAFI's qualifications. Information may be received as data that is input directly into the FAFI System 101 with a computer input device, such as a keyboard, pointing device, voice recognition or other device. In one example a graphical user interface (GUI) or application program interface (API) may be utilized to ease the data input. Data may also be received via an electronic communication, such as a data feed, e-mail, or TAFI 111-114 submission. Typically the data will be received into structured fields in a database, however, data may also be received as unstructured information, such as in the form of an abstract, biographical or resume descriptive of a TAFI 111-114.

TAFI information may include any data descriptive of a TAFI 111-114 that may be of interest to a potential TAFI investor 102-106 or other interested party, such as, for example a technology facilitator. TAFI information may include objective and/or subjective data, biographical information, demographic information, description of a TAFI's accomplishments, class standing, political objectives, business objectives, academic objectives or other information relating to a TAFI 111-114 and/or the TAFI's 111-114 intended plans.

At 211, The FAFI System 101 may also receive technology investment criteria indicative of attributes, qualities, accomplishments and/or investment details specified by a TAFI investor 102-106 to be conditions precedent to investment in a technology. Examples of investment criteria may include a rate of return on investment to the TAFI investor 102-106; increasing the tax leverage of a TAFI investor's 102-106 charitable giving; a projected after tax financial return sufficiently in excess of an IRS annuity factor applicable to CLAT 132 to meet a TAFI investor's 102-106 return criteria for heirs; participation in a particular industry; TAFIs who attend a particular learning institution or curriculum; TAFIs who possess particular attributes; TAFIs related to a particular field of innovation; or any other criteria put forth by a TAFI investor. Presentation of the criteria to a TAFI investor 102-106 may be accomplished via hardcopy or via an electronic interface, such as a graphical user interface.

At 212, The FAFI System 101 may analyze the TAFI 111-114 information according to the investment criteria in order to determine those TAFIs that meet the criteria set forth by a specific TAFI investor 102-106.

At 213, results of the analysis according to investment criteria may be presented via a GUI, text document, printed report, electronic message, or other method.

Presentation of TAFI analysis may be accomplished electronically via a model generated by the computerized FAFI System 101, through a hardcopy prospectus, or other communication media. In some embodiments, a graphical user interface (GUI) such as those further discussed below may be utilized to present the investment criteria 213 and TAFI attributes. If appropriate, a technology investment structuring model that targets the development of a particular area of technology may be generated by the FAFI System 101 and present how one or more TAFIs may meet specified technology investment criteria 213. For example, if investment criteria include a philanthropic motive, the model may illustrate how a particular TAFI 111-114 or portfolio of TAFIs addresses the philanthropic motive. If criteria include financial objectives, the FAFI System 101 may generate financial models which may illustrate how a TAFI with the qualifications quantified will meet those objectives.

At 214, in another embodiment, the FAFI System 101 may present TAFI information for browsing. Browsing may also be accomplished, for example, through an electronic interface or via a printed document.

At 215, an instruction to invest in a TAFI 111-114 may be received by the FAFI System 101. Typically, an investment instruction will be received from a TAFI investor 102-106 that has been identified to the FAFI System 101. In some embodiments, credit limits and/or collateral arrangements have been previously arranged for an investor allowing the investor to openly engage in the buying and selling of PondBonds and/or PondBond based ETF securities. However, in the event such payment arrangements have not been made, the FAFI System 101 may branch to an automated system for quantifying payment terms, or refer the TAFI investor 102-106 to an account representative.

At 216, Funds may be allocated according to a technology investment instruction received. In those instances where it is required, approval for an instruction received may be accepted via a an electronic signature, logon password, secure ID, or any other well-known method for identifying a user accessing a computer system that may be utilized to sufficiently associate an instruction with a particular TAFI investor 102-106. In addition to other well-known methods, allocation may be accomplished via disbursement of funds managed by the ASI system provider, via an instruction to a financial institution, or by transfer directly from TAFI investor 102-106 to a TAFI.

At 217, the FAFI System 101 may also track an ongoing TAFI status including attributes, financial data or other information related to the TAFI 111-114. Capital calls or other investment installments into an investment entity may be made contingent upon the attainment of interim or final goals set for the TAFI 111-114 and may also be tracked by FAFI System 101. The attainment of interim or final goals may increase the value of a TAFI investor's 102-106 position in a TAFI 111-114. TAFI investor 102-106 positions may be traded or otherwise transferred. Therefore interim goals may be key to a TAFI investor 102-106 exit strategy.

An automated TAFI investment intermediary 115-118 may also track activities relating to the management of a TAFI 111-114 and/or portfolio and present relevant information on an ongoing basis. For example, an automated TAFI investment intermediary 115-118, such as a philanthropic trust, a financial institution, or an educational institution may receive funds from a TAFI investor 102-106 and distribute the funds according to a schedule quantified in a TAFI 111-114 contract. The TAFI investment intermediary 115-118 may receive information relating to a TAFI 111-114 on an ongoing basis and present the information to TAFI investor 102-106 or others. When the remuneration period is entered into, the TAFI investment provider may coordinate payments to the TAFI investor 102-106.

At 218 the FAFI System may calculate an annual income, revenue generated or other monetization related to a TAFI. At 219, it may track allocation and at 220 it may track allocation.

The FAFI System 101 may compare TAFI information allowing a TAFI investor 102-106 to make informed decisions concerning investment or holdings in TAFIs associated with a particular learning institution, industry type, geographic area other criteria. In addition, it may calculate and present specific details relating to an investment vehicle. For example, an FAFI System 101 may generate a report illustrating the value of an ownership interest in a particular LLC or the value of shares in a technology contract with a particular TAFI, or the value of shares in a portfolio of technology contracts.

At 221, the computerized FAFI System 101 may also receive instructions 222 to reallocate funds associated with a particular investment and track 223, report 224 and compare 225 reallocation in various manners of the funds according to the instruction received. For example, reallocation may involve selling a position in a portfolio of a first TAFI and invest in a second TAFI or to sell some or all of a position in a first fund of TAFI's and/or purchase a position in a second fund of TAFIs. Other functions of the computerized FAFI System 101 may include transmitting or displaying an investment history. The investment history may be, for example, a history related to a particular TAFI 111-114 or portfolio, or a history related to a particular LLC, learning institution, business venture, or other specification.

In some embodiments, a donor advised fund may be used in conjunction with a CLAT 132. The donor advised fund may be designated as the beneficiary of the charitable contribution. Utilization of a donor advised fund allows an FAFI System 101 to receive instructions to direct money held in the fund to a particular TAFI SPE 133 or portfolio and track allocation of the funds according to the instruction received. In addition, the present invention may display charitable giving history detailing the allocation of funds related to a particular CLAT. Accordingly, it is possible for a TAFT SPE Investment 134 to fund a donor advised fund and advise on its distribution over a term of years that is longer than the lead term of the trust. For example, a donor may accumulate $90,000 in a donor advised fund through six consecutive annual donations of $15,000 each and then direct the distribution of the $90,000 from the donor advised fund for a term of years extending beyond the six years.

A TAFT contract index generated by the present invention may be calculated in various ways; such as Equally Priced in which all of the contract prices are added up and divided by the total number of bonds, contracts or other financial instruments; or capitalization weighted in which the index is based upon a price of a TAFT contract or portfolio share times the number of shares outstanding; or other algorithms including averaging of share prices.

Referring now to FIG. 2B, a list of method steps that may be used in some embodiments of the present invention is illustrated. The listed steps are meant to be exemplary and do not limit the scope of the present invention. At 230 a TAFT SPE may receive funds. The funds may be received, for example, by way of sale of a financial instrument, such as a bond instrument, a contract, an equity instrument or other investment document. At 231, an analysis of a TAFT associated with the SPE is performed. The analysis may indicate IP potential related to the SPE. At 232, Quantifiable IP assets are generated. The IP Assets may include, for example, one or more of: patents, copyrightable material, trade secrets, know how, methods, compositions of matter, apparatus and executable code.

At 233, in some embodiments, IP Assets generated and/or acquired by a SPE may be pooled with IP Assets from an entity other than the TAFT SPE. The IP Assets from an entity other than the TAFT SPE may be complimentary to IP Assets generated and/or acquired by a SPE, or related in some manner.

At 234, revenue may be received via monetization of IP Assets. Monetization may include, for example, license of IP, disclosure of knowhow, sale of IP, sale of products or services, sale of IP or even sale of the SPE or an interest in the SPE.

At 235, a SPE or related entity may pay, or cause to be paid, obligations of the PSE and/or obligations according a financial instrument associated with the SPE. At 236, in some embodiments, a transfer of TAFT SPE assets to another SPE may be executed and at 237 obligations of the second SPE may also be fulfilled. At 238, a SPE may be closed and funds associated with the SPE may be distributed.

Referring now to FIG. 2C, in another aspect of the present invention, an investment advisor or other individual or entity may receive TAFI information and qualifications. At 241, they may receive a rating of likelihood of success of one or both of a TAFI and a TAFI SPE. Success of a TAFI may be rated according to various aspects, including, by way of non-limiting example, one or more of: scientific standards, such as a proven breakthrough in technology; commercialization of a technology; a market value of an applied TAFI; and likelihood of success. Success may also be rated according to terms and conditions associated with a TAFI SPE, including, by way of non-limiting example, one or more of: terms included in a SPE charter; a management team associated with a TAFI SPE; a technical team associated with a TAFI SPE; a rate of return on investment; a length of years of investment; a fund or index in which a TAFI SPE may be included and other factors.

At 242 available TAFIs may be analyzed according to investor criteria. For example, a particular investor may be most interested in one or more factors listed above for rating the success of a TAFI or TAFI SPE and at 243, the analysis of the TAFIs may be presented.

At 244, an instruction relating to investment maybe received. An instruction for investment may include one or more of: investing in a particular TAFI, even if the TAFI is associated with multiple TAFI SPEs; investing in a particular TAFI SPE; investing in a fund or index associated with a TAFI or other criteria.

At 245, funds may be allocated according to an investor instruction and at 246 track ongoing TAFI and/or TSPE status. At 247 TAFI and/or SPE revenue may be calculated and at 248 assignment of SPE revenue to an associated fund may be tracked.

At 249, ongoing data may be used to refine success algorithms and models. Generally, the models become more sophisticated and accurate as historical data is added. At 250, refined algorithms and data processing methods may be used to analyze subsequent TAFIs and SPEs based upon historical knowledge and extrapolated trends.

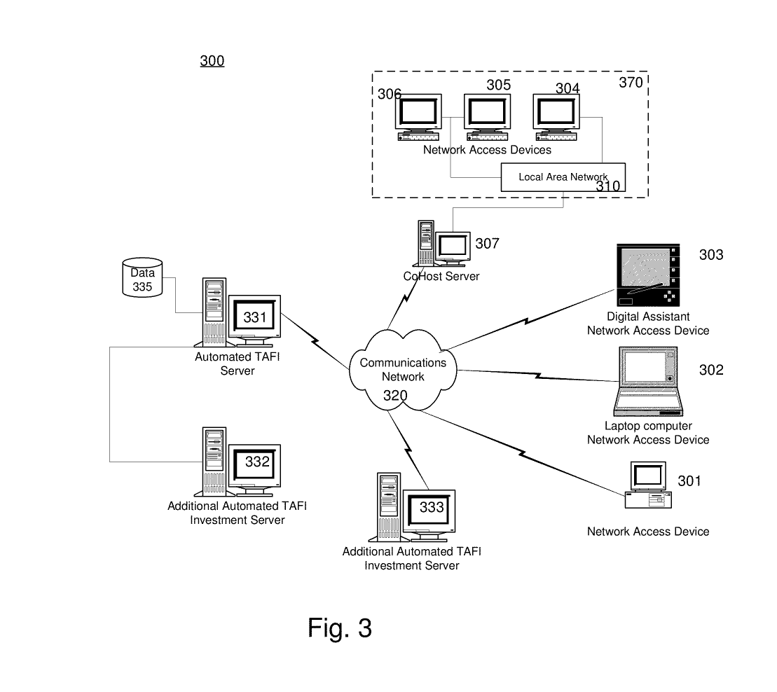

FIG. 3 shows a network 300 of computers that may be used in an implementation of an automated system for facilitating financial structuring. The network 300 includes an automated ARDI server 331 or other host system and client computers 301-306. Each of the client computers may include a processor, memory, a user input device, such as a keyboard and/or mouse, and a user output device, such as a video display and/or printer. The client computers 301-306 may communicate with the technology server 331 to obtain data stored at the technology server 331. The client computer 301-306 may interact with the ARDI Server 331 as if the ARDI Server 331 was a single entity in the network 300. However, the ARDI Server 331 may include multiple processing and database sub-systems, such as cooperative or redundant processing and/or database servers 333, which may be geographically dispersed throughout the network 300. In addition, there may be more than one occurrence of a host server 332. In some implementations, groups of client computers 304-306 may communicate with technology server 331 through a local server 307. The local server 307 may be a proxy server or a caching server. Server 307 may also be a co-host server that may serve financial structuring content and provide services such underlying assets 107 details and trust management data relating to a particular CLAT 132, to user at client computers 304-306.

The FAFI system 101 includes one or more databases which may store data relating to TAFIs 106, TAFI investor 102-106, market data, charities, past performance of investment in TAFIs, or other information conducive to making investment in a TAFI 111-114. A large variety of investment related materials may be stored at the technology TAFI server 331, for example, text, data, charts, audio, video, graphics, animations, and illustrations. In addition, the technology TAFI server 331 may interact with, and gather data from a user at a client computer 301-306. Data gathered from the user may be used for making investments in a TAFI's future 103, fulfilling terms of a TAFI contract 110, allocating funds, investing in underlying institutions or entities, IP generated by a SPE and any other activity associated with investment in SPEs associated TAFI's 111-114, the TAFI, TAFI earnings or net worth.

A user may access the ARDI Server 331 using client software executed at the client's computer 301-306. The client software may include a generic hypertext markup language (HTML) browser, such as Google Chrome, Firefox, Safari, Opera or Microsoft Internet Explorer, (a “WEB browser”). The client software may also be a proprietary browser, and/or other host access software. In some cases, an executable program, such as a Java™ program, may be downloaded from the technology server 331 to the client computer and executed at the client computer.

The technology server 331 may receive as input multiple forms of data. For example the technology server 331 may receive data descriptive of a TAFI 111-114, market data, and demographic data. Data may be received as data input into fields on a form presented on a graphical user interface (GUI), or received via an electronic data feed, such as from a government agency, news feed or commercial data provider such as Bloomberg or Thomson. Received data may be structured and organized into reference able format such as a database table.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. Preferably the invention will be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language or in assembly or machine language if desired; and in any case, the language may be a compiled or interpreted language. Suitable processors include, by way of example, both general and special purpose microprocessors.

Automated devices such as network access devices or client computers 301-307 and servers 331-332, in an automated TAFI investment system shown as network 300 may be connected to each other by one or more network interconnection technologies, such as a communications network 320. For example dial-up lines, and/or Ethernet networks 310, T1 lines, wireless links, cable modems and any other form of electronic communication method may all be combined in the network 300. Other packet network and point-to-point interconnection technologies may also be used. Additionally, the functions associated with separate processing and database servers in the technology server 331 may be integrated into a single server system or may be partitioned among servers and database systems that are distributed over a wide geographic area to store data 335.

By way of non-limiting example, client computers 301-307 may comprise a personal computer executing an operating system such as Microsoft Windows™, UNIX™, Linux or an Apple Mac™ operating system, as well as software applications, such as a web browser. Client computers 301-307 may also be terminal devices, or a mobile phone WEB access device, a tablet that adheres to a point-to-point or network communication protocol such as the Internet protocol. Other examples may include TV WEB browsers, terminals and wireless access devices (such as an Android device). A client computer or other Web Access Device may include a processor, RAM and/or ROM memory, a display capability, an input device and hard disk or other relatively permanent storage. Interactive graphical user interfaces specifically related to information generated as a result of the workings of the financial structuring system may include any information contained within databases relating to the financial structure, or derivative of such information.

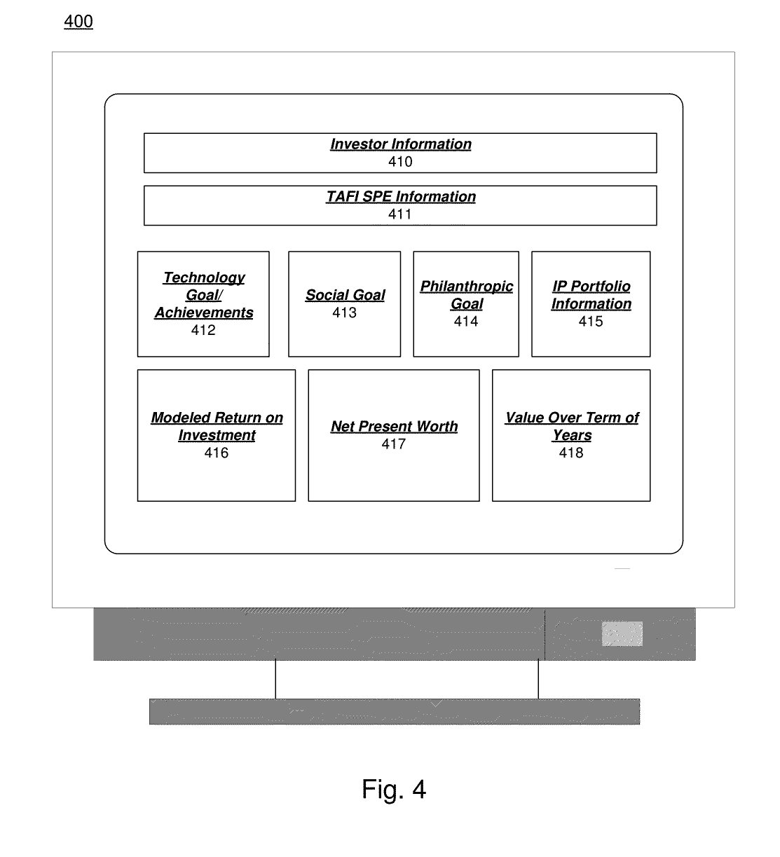

Referring now to FIG. 4, an interactive graphical user interface (GUI) 400 operable in conjunction with a network access device, may be used to present the functions of an FAFI System 101. Interactive user areas on the display may include: an area for TAFI investor data 410, an area for TAFI SPE Information 411, and area for data relating to TAFI goals and/or achievements 412, an area for data relating to TAFI Social Goals 413, an area for details relating to a Philanthropic with which a TAFI may be associated 414 and an area for information related to TAFI IP Portfolios 415. Other interactive areas may include an area to display or input investment return criteria and predicted and/or actual Return on Investment 416, Net Present Worth 417, and/or details pertaining to a longer term valuation over a term of years 418. In one embodiment an investor may generate one or both of a buy order and a sell order associated with an interest in a TAFI SPE or a Fund of TAFI SPEs to manage investment in a TAFI via the interactive GUI 400. The offer may indicate standard terms as discussed previously, or specific terms that may be further detailed by an investor.

A TAFI PSE may accept an offer for investment, make a counter offer, or present an original offer via a TAFI GUI as discussed in more detail below. A contract may be generated in hardcopy and executed manually by each party, or a contract may be executed via the FAFI System 101 through the use of electronic signatures that are legally binding. In addition, or alternatively, a provider of an FAFI System may enter into contract with a TAFI SPE binding the TAFI SPE to investment terms entered into by the FAFI System or other transaction medium.

The TAFI investor data area 410 may include user interactive devices such as editable fields, or icons, to enable functions for the entry, display and editing of information descriptive of a TAFI investor. In particular, the area for TAFI investor data may allow entry, display and editing of data including the name of a TAFI investor, address, age, tax identification number, such as a social security number, age of the TAFI investor, and other details related to a financial structure. An area for TAFI data may contain similar type data as well as proposed initiatives, future goals, and data descriptive of any facet of the TAFI's.

The interactive area for asset return criteria may include, for example, a required cash flow over a term of years, feasible upsides to an investment, benefits that may arise from a statutory deduction for donation to a charitable organization, or any other information relating to the financial benefits of a specific investment property.

The interactive area for investments goals may include, for example, charitable gift giving intentions over a term of years, tax planning data, transfer of wealth relating to estate planning, cash flow needs of the TAFI investor and any other goals specific to an individual TAFI investor

The area for investment structure may include specific recommendations for financial investment, which will satisfy the investment goals while utilizing the underlying assets. The specific recommendations may include, for example, an amount of money which needs to be invested, a term of years for a contract, an annual interest dividend, a final projected payout, or other related details.

Other interactive user interfaces, operable in conjunction with a network access device, may be used to enter, display or edit information relating to a specific underlying asset, such as IP Assets generated and quantified by a SPE, as well as calculations illustrating how an investment in the underlying asset may perform and the effect the performance may have on a TAFI investor's goals. For example, one interactive area may display a summary of TAFI investor returns composite-leveraged, another area may contain project economics, including a down scenario, a base scenario and an up scenario.

While the above description contains many specific examples, these should not be construed as limitations on the scope of the invention, but rather as an exemplification of one preferred embodiment thereof. Many variations are possible; for example, the FAFI System may facilitate investment in a single TAFI that demonstrates particular attributes of interest to a TAFI investor, investment in a portfolio of TAFIs sharing a specific attribute, or investment in a portfolio of TAFIs that are purposely diverse. Additionally, the present invention may include an exchange for executing a transaction that provides for investment in an individual or portfolio.

While a number of embodiments of the present invention have been described, it will be understood that various modifications may be made without departing from the spirit and scope of the invention. For example, client computers 301-307 may comprise a personal computer executing an operating system such as Microsoft Windows™, UNIX™, Linux or Apple MacOS™, as well as software applications, such as a web browser. Client computers 301-307 may also be terminal devices, or a palm-type computer WEB access device that adheres to a point-to-point or network communication protocol such as the Internet protocol. Other examples may include TV WEB browsers, terminals and wireless access devices (such as a smart phone or tablet). A client computer may include a processor, RAM and/or ROM memory, a display capability, an input device and hard disk or other relatively permanent storage. Interactive graphical user interfaces specifically related to information generated as a result of the workings of the financial structuring system may include any information contained within databases relating to the financial structure, or derivative of such information.

Exchange Traded Fund (ETF) as used herein, an exchange-traded fund (ETF) includes an investment fund traded on stock exchanges, much like stocks. An ETF holds similar assets including PondBonds, and trades close to its net asset value over the course of the trading day. ETFs may be attractive as investments because of their low costs, tax efficiency, and stock-like features. ETFs are the most popular type of exchange-traded product.

Asset Backed Security (ABS), as used herein, shall mean a financial security backed by a loan, lease or receivables against assets other than real estate and mortgage-backed securities.

Security Interest, as used herein, shall mean a legal claim on collateral that has been pledged, usually to obtain a loan. The borrower provides the lender with a security interest in certain assets that can be repossessed if the borrower 1) stops making loan payments or 2) performs or fails to perform some specified action or 3) makes a prohibited action or 4) fails to obtain written approval for some specified action in a particular timeframe. The lender may then take ownership of, and sell repossessed collateral to pay off the loan and any accrued interest and share in remaining proceeds. A transaction in which a security interest is granted is called a secured transaction. The Uniform Commercial Code specifies that the three requirements for a security interest to be legally valid are (1) the security interest is given a value, (2) the borrower owns the collateral and (3) the borrower has signed the security agreement. If the business stopped paying its loan due to bankruptcy, its secured lenders would have precedence over the business's unsecured lenders in making claims on the business's assets.

Intellectual Property (IP), as used herein shall mean a collection of one or more of: 1) a patent 2) software source code 3) copyrighted materials (publications, recordings, documentation) 4) knowhow (as in expert knowledge, machine settings and calibrations, maintenance requirements and also includes “derived works” to all of the above in our goal of creating a broad portfolio of IP for Universities.

Standard Essential Patent, as used herein, shall mean a standard-essential patent is a patent that claims an invention that must be used to comply with a technical standard. Standards organizations, therefore, often require members disclose and grant licenses to their patents and pending patent applications that cover a standard that the organization is developing. If a standards organization fails to get licenses to all patents that are essential to complying with a standard, owners of the unlicensed patents may demand or sue for royalties from companies that adopt the standard.

Fair, Reasonable, And Non-Discriminatory terms (FRAND), as used herein shall mean a licensing obligation that is often required by standards organizations for members that participate in the standard-setting process.

Patent Pool, as used herein shall mean a consortium of at least two companies agreeing to cross-license patents relating to a particular technology. The creation of a patent pool can save patentees and licensees time and money, and, in case of blocking patents, it may also be the only reasonable method for making the invention available to the public. Competition law issues are usually important when a large consortium is formed.

PondBond: as used herein, shall mean an asset backed security comprised of IP rights. The IP rights will typically include global exclusive rights to license University/Inventor patents. They also include exclusive rights to license derivative works of all forms of IP related to the original patent, patent applications or ideas in the Targeted Area For Innovation.

PondBond ETF: as used herein, shall mean a set of PondBonds that are packaged into a single security instrument available for trading.

Targeted Area For Innovation: TAFI as used herein, shall mean a description of the inventions that are funded by a PondBond and developed by the Special Purpose Entity (SPE). Examples include: Intravascular Blood Gas Monitoring Devices, Metallic 3D Printing, and Solar Sea Sterling Engines.

Targeted Industry For Innovation: TIFI as used herein shall mean an emerging area of science that can support many multi-billion dollar businesses as the markets reach their maturity during the life of the PondBond ETF. For example, a TIFI may be related to “implantable monitoring devices” or “autonomous delivery systems” or “microbe remediation”. A TIFI is used to define a group of TAFI's. Each PondBond funds a TAFI, a set of PondBonds assembled into a PondBond ETF is thereby focused on a TIFI.

Functional Proof of Concept: FPOC This represents a set of IP that can be software, prototypes, demos of processes, which illustrate typically just the basic and core innovative functional aspects of an invention. The investment in building a FPOC is to help provide a level of comfort to a lay investor that the invention is indeed feasible to build. A FPOC may not be a product, in some embodiments it is simply a design which enables people to see core concepts working.

Commercially Oriented IP: as used herein includes an asset that is created by the Springtime management process for a SPE TAFI. Assets may include, by way of non-limiting example, one or more of:

A) patent filings with 1) durable claims language crafted to support litigation 2) accelerated filings with all relevant research completed, 3) extensive prior art research & 4)

B) copyrightable works (source code, documentation, works of art, videos, recording)

C) licensable products (molecular constructs, machines, semi-conductors)

D) functional proofs of concept, demos, prototypes

E) trade secrets; and

F) Know-How.

Other functionality and details not specifically listed may also be included in the spirit of the present invention. Accordingly, other embodiments are included within the scope of the following claims.

What is claimed is:

1. An automated trading apparatus for improving market access and liquidity for targeted areas of innovation, the apparatus comprising:
a computer server accessible with a network access device via a digital communications network, said computer server comprising a processor and a digital storage; and
executable software stored on the digital storage and executable on demand, the software operative with the computer server to cause the apparatus to:
receive data descriptive of an innovative technology;
categorize the data descriptive of the innovation technology into a targeted area of innovation;
receive data descriptive of an investment vehicle supporting development of the targeted area of innovation;
transmit a graphical user interface to the network access device via the communications network, wherein the graphical user interface comprises details of the targeted area of innovation and the investment vehicle and the graphical user interface may be transformed into a human readable format and receive input from a human;
associate the network access device with an investor;
receive an instruction from the network access device to make an investment in the investment vehicle on behalf of the investor and according to specific investment conditions; and
generate an instruction to execute a transaction based upon the instruction received from the network access device.

2. The automated trading apparatus of claim 1 wherein the software is additionally operative to cause the apparatus to model an expected return on investment for the investment vehicle supporting development of the targeted area of innovation.

3. The automated trading apparatus of claim 1 wherein the software is additionally operative to cause the apparatus to complete steps to:
receive an investment objective from the investment vehicle supporting development of the targeted area of innovation; and
calculate a determination indicative of a likelihood of the investment vehicle's fulfilling the objective.

4. The automated trading apparatus of claim 1 wherein the software is additionally operative to cause the apparatus to:
present a list of targeted areas of innovation associated with a particular investment vehicle;
structure repayment terms for an investment in a targeted area of innovation on the list, wherein the repayment terms are conditional upon financial performance of the investment vehicle; and
receive an instruction to invest in one or more of the targeted areas of innovation presented on the list according to the structured terms.

5. The automated trading apparatus of claim 4 wherein investment is made in all targeted areas of innovation on the list.

6. The automated trading apparatus of claim 4 wherein the investment vehicle is a limited liability company.

7. The automated trading apparatus of claim 1 wherein the software is additionally operative to cause the apparatus to:
create a contract to receive an amount of money related to technological success of a targeted area of innovation future, wherein the contract specifies one or more conditions of technological success;
store terms of the contract on the computer server; and
transmit over the communications network the terms of the contract to network access device associated with an investor.

8. The automated trading apparatus of claim 7 wherein the software is additionally operative to receive an instruction via the communication network to purchase the contract.

9. The automated trading apparatus of claim 7 wherein the software is additionally operative to:
calculate a value for an option to purchase the contract relating to a value associated with the targeted area of innovation;
transmit the value for an option to the network access device via the communications network; and
receive a communication comprising an instruction to purchase of the option.

10. The automated trading apparatus of claim 1 wherein investment is made on behalf of an underlying investment vehicle.

11. The automated trading apparatus of claim 10 wherein the software is additionally operative to cause the apparatus to track a membership interest in the underlying investment vehicle commensurate with a capital contribution to the underlying investment vehicle.

12. The automated trading apparatus of claim 11 wherein the underlying investment vehicle is a charitable lead annuity trust.

13. The automated trading apparatus of claim 12 wherein the software is additionally operative to cause the apparatus to track distribution of funds to a predetermined beneficiary upon expiration of a lead term of the charitable lead annuity trust.

14. The apparatus of claim 1 wherein the network access device comprises a wireless mobile device.

15. The apparatus of claim 1 wherein the computer communication network conforms to a transmission control protocol/internet protocol.

16. The apparatus of claim 15 wherein the computer communication network comprises the Internet.

17. The apparatus of claim 1 wherein the investment vehicle comprises a pondbond.

18. The apparatus of claim 1 wherein the investment vehicle comprises an exchange traded fund.

19. The apparatus of claim 1 wherein the investment vehicle comprises special purpose vehicle.

20. The apparatus of claim 1 wherein the software is additionally operative to receive an indication of receipt of a payment of an ongoing financial obligation related to investment in the investment vehicle.
